(19) United States
(12) Patent Application Publication
(10) Pub. No.: US 2015/0217314 A1
(43) Pub. Date: Aug. 6, 2015

(54) Fluid Dispenser with Increased Stability

(71) Applicant: J.S. PASRICHA ENTERPRISES, LLC, San Antonio, TX (US)

(72) Inventor: Hardave Singh Kharbanda, San Antonio, TX (US)

(21) Appl. No.: 14/430,209

(22) PCT Filed: Sep. 20, 2012
(86) PCT No.: PCT/US2012/056168

§ 371 Date: Mar. 20, 2015

(51) Int. Cl. B05B 11/00; B65D 83/38

(52) U.S. Cl. CPC B05B 11/3001; B65D 83/38; B05B 11/0037

(57) ABSTRACT

A dispenser with increased stability includes a pillar tube (12) extending from the stem-spring chamber assembly (208, 212) at the top of the fluid reservoir (216) to the bottom surface (217) of the fluid reservoir (216). The pillar tube (12) transmits the force that the user employs to dispense fluid from the hand of the user to a pressure sensitive attachment device (202) at the bottom surface (217) of the fluid reservoir (216).

### CROSS REFERENCE TO RELATED APPLICATION

This application claims the benefit of Non-Provisional U.S. patent application Ser. No. 13/420,447 filed 14 Mar. 2012.

### STATEMENT REGARDING FEDERALLY FUNDED RESEARCH AND DEVELOPMENT

The invention described in this patent application was not the subject of federally sponsored research or development.

### TECHNICAL FIELD

The present invention pertains to fluid dispensers; more particularly, the present invention pertains to a fluid dispenser of the type typically located on the edge of a sink for providing a user with small amounts of liquid soap, liquids, lotions, as well as an atomized or mist spray.

### BACKGROUND ART

The numerous parts included in the top portion of a dispenser of the type typically found on the edge of a sink create its high center of gravity and thus its instability. This instability is the source of the inconvenience that results from the pump dispenser being either tipped over or moving away from the user when the hand of the user is placed thereon.

An analysis of the forces on a dispenser reveals that the action of placing manual force on the top of a dispenser to dispense a small amount of fluid will cause the dispenser to tip over or to move along the surface on which the dispenser rests, unless the user happens to be exerting a force that is directly along the vertical axis of the dispenser and vertically above the center of gravity of the dispenser.

Those dispensers that are close to being empty are less stable and more prone to being tipped over and moving when the force from a user's hand is exerted thereon.

Some dispensers are relatively tall compared to the diameter of their bottom surface. Such dispensers also tend to tip over when the force of a user's hand is exerted thereon to dispense a small amount of fluid.

While liquid is contained in the dispenser, it is not unusual for a small amount of dispensed liquid to either seep underneath or flow around the bottom surface of the dispenser. This small amount of dispensed liquid will make the surface upon which the dispenser rests slippery. The resulting effect is that the frictional forces that prevent the dispenser from moving across the surface on which it rests are reduced.

Several attempts to prevent dispensers from tipping over or sliding over the surface on which the dispenser rests have been made. These attempts include shaping a dispenser to have a relatively large bottom surface; constructing the bottom portion of the dispenser from a relatively heavy material; making the entire dispenser from a relatively heavy material; placing the dispenser within a stable basket or wire frame; or, some combination of the foregoing. These attempts to solve the problem of instability of a dispenser generally prevent the dispenser from tipping over or prevent the dispenser from moving over the surface on which it rests by causing the dispenser to have a lower center of gravity and/or greater total mass.

Another common way of keeping a dispenser, particularly a pump dispenser for liquid soap, from tipping over or moving over the surface on which the dispenser rests has been to attach a suction cup to the bottom surface of the dispenser. However, after an individual has endeavored to create a suction connection of the suction cup to the surface on which the pump dispenser rests through the application of firm downward force on the main pump dispenser structure, it takes only a short period of time for air to seep underneath the suction cup. This seepage causes the suction connection of the suction cup to the surface on which it rests to first weaken and then to be lost entirely.

The period of time between uses of a pump dispenser having a suction cup thereon is typically long enough to cause the suction connection associated with the previous use of the pump dispenser to weaken or even be lost. Once the suction connection is weakened or lost, the user must begin the next use of the dispenser by re-establishing the suction connection.

Users of dispensers typically do not check or re-establish the suction connection at the bottom of a dispenser prior to every use of the dispenser.

It has been found that after the suction connection from the prior use of the dispenser has been either weakened or lost, the first downward stroke in the next use of the dispenser has the potential to cause the dispenser to tip over or move over the surface on which it rests even when a suction cup is attached to the bottom of the dispenser. The first downward stroke in the use of a dispenser after the suction connection has been weakened or lost does not reliably transmit force to the top of the suction cup at the bottom of the dispenser in a way that strongly and immediately re-establishes a suction connection, for reasons that will be explained below.

The inability of the suction cup to reliably prevent a dispenser from tipping over or sliding over as it is begun to be used is likely a significant reason that many manufacturers have apparently decided to stop attaching suction cups to the bottom surfaces of their dispensers.

U.S. Pat. No. 2,736,468 to Hills, entitled “Liquid Soap Dispenser,” describes a convenient way of applying force to the top of a suction cup attached to a dispenser to re-establish a suction connection. In this reference, the fluid reservoir of the dispenser is shown as being attached to a vertical surface. Therefore, the suction cup is attached to a side surface of the fluid reservoir. To put force on the suction cup to establish a suction connection, the user presses on the side surface of the fluid reservoir at the location that is opposite to the attachment point of the suction cup. Two inward, beam-like projections are affixed to the inner surface of the fluid reservoir, at the location that is opposite to the attachment point of the suction cup and at the location where the suction cup is attached to the fluid reservoir. When the user presses on the side surface of the fluid reservoir at the location that is opposite to the attachment point of the suction cup, the projection located where the user exerts force comes into contact with the projection located at the suction cup. The suction cup is therefore depressed and the suction connection of the fluid reservoir of the dispenser to the vertical surface is re-established.

Although the invention in U.S. Pat. No. 2,736,468 provides an easier way of re-establishing a suction connection than having to grasp and push on the entire reservoir of the fluid contained within a dispenser, it still does not offer a solution to the greater problem of needing to actively re-establish a weakened or lost suction connection prior to each use of a dispenser.

Accordingly, the need remains in the art for a fluid dispenser that does not require an active re-establishment of the suction connection of the dispenser to the surface on which the dispenser rests prior to each use of the dispenser.

### DISCLOSURE

The disclosed invention provides a construction for a dispenser that links the action of dispensing fluid from a dispenser to the re-establishment or reinforcement of the attachment of the dispenser to the surface on which it rests.

The disclosed construction for a dispenser involves the placement of a force sensitive attachment device, such as a suction cup, at the bottom of a dispenser. The disclosed construction of a dispenser also includes a spring chamber assembly at the top of the dispenser. The spring chamber assembly receives force from the hand of the user and enables a small quantity of fluid from within the fluid reservoir to be dispensed. Extending downwardly from the spring chamber through the fluid reservoir is an internal pillar tube. It is the internal pillar tube within the fluid reservoir that transmits mechanical force to the force sensitive attachment device located on the bottom of the dispenser.

Thus, the force exerted by the user on the top of the dispenser not only dispenses a small quantity of fluid but also quickly and firmly re-establishes or reinforces the attachment of the bottom of the dispenser to the surface on which the dispenser rests.

### BRIEF DESCRIPTION OF DRAWINGS

A still better understanding of the fluid dispenser with increased stability may be had by reference to the drawing figures wherein:

FIG. 1 is a front elevational view, in cross section, of an unstable prior-art pump dispenser;

FIG. 2 is a front elevational view, in cross section, of an embodiment of a liquid dispenser with increased stability of the present invention;

FIG. 3A is a front elevational view, in cross section, of a first alternate embodiment of the pillar tube;

FIG. 3B is a front elevational view, in cross section, of a second alternate embodiment of the pillar tube;

FIG. 4A is a front elevational view, in cross section, of a first alternate embodiment of the bottom surface of the fluid reservoir and the suction cup;

FIG. 4B is a front elevational view, in cross section, of a second alternate embodiment of the bottom surface of the fluid reservoir and the suction cup;

FIG. 4C is a front elevational view, in cross section, of a third alternate embodiment of the bottom surface of the fluid reservoir and the suction cup;

FIG. 4D is a front elevational view, in cross section, of a fourth alternate embodiment of the bottom surface of the fluid reservoir and the suction cup;

FIG. 5 is a front elevational view, in cross section, of the bottom surface of the fluid reservoir and the suction cup including magnetic pieces;

FIG. 6 is a front elevational view, in cross section, of an embodiment of the disclosed invention in an aerosol dispenser; and

FIG. 7A is a front elevational view, in cross section, of an embodiment of the disclosed invention in a Misto®-type dispenser. FIG. 7B is an enlarged view of part of FIG. 7A.

### MODES FOR CARRYING OUT THE INVENTION

Three types of dispensers will be used to exhibit embodiments of the disclosed invention. The first of these dispensers will be a pump dispenser, where the force from the user's hand is used to dispense a small amount of fluid. The second type of dispenser to be shown will be an aerosol dispenser, where pressure from within the fluid reservoir propels fluid out of the dispenser in the form of droplets as a result of a force on the dispenser from the user's hand. The third type of dispenser to be shown will be a Misto®-type dispenser, named in reference to the Misto® Gourmet Olive Oil Sprayer manufactured by Misto International LLC of Bethel, Conn., USA, where several applications of force to a slide pump from the user's hand are required to pressurize the dispenser. The pressure within the dispenser established by the user is then used to propel fluid from within the fluid reservoir in the form of droplets as a result of an additional force on the dispenser from the user's hand.

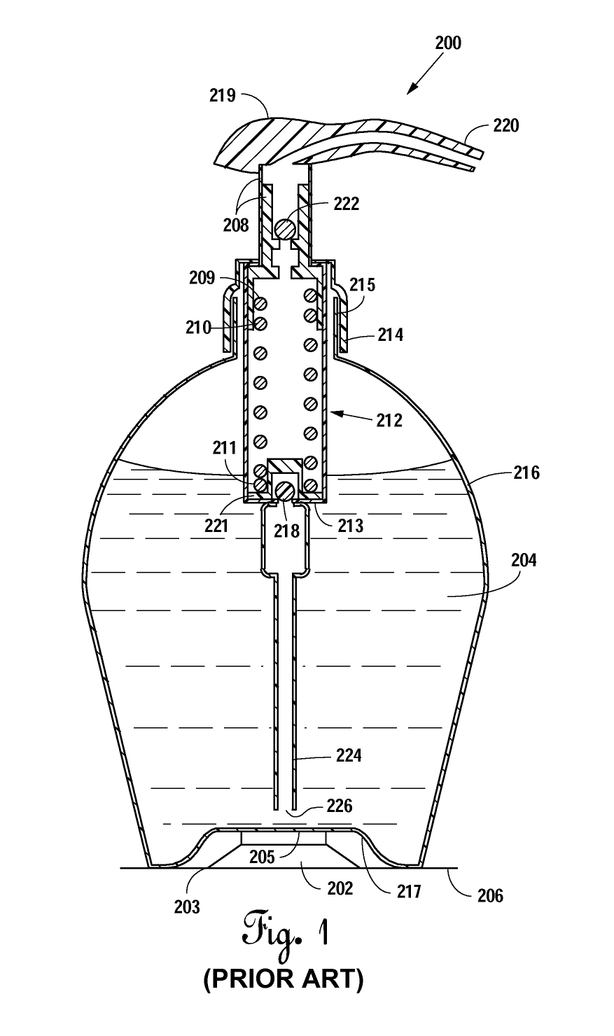

To provide a better understanding of the first embodiment of the disclosed invention to be shown, i.e., an embodiment of the disclosed invention in a pump dispenser, the components of the basic construction of a typical prior-art pump dispenser 200 with a suction cup 202 attached to its bottom surface are shown in FIG. 1.

A description of the operation of the prior-art dispenser 200, as well as a description of its associated force transmission, will be given below to make it easier to explain how the first embodiment of the disclosed invention to be shown utilizes the force exerted by the hand of the user on the top of a pump dispenser to both dispense fluid and to re-establish or reinforce the suction connection of the suction cup 202 at the bottom of the pump dispenser to the surface 206 on which the dispenser rests.

Those of ordinary skill in the art will understand that the fluid 204 dispensed by a prior-art pump dispenser 200 may be a liquid or a flowable semi-solid or a gas. The fluid 204 dispensed from the pump dispenser 200 exits the nozzle 220 as a stream, as droplets, as a mist, or as foam.

Those of ordinary skill in the art will appreciate that the cap 214 shown on the neck 215 at the top of the fluid reservoir 216 of the typical prior-art pump dispenser 200 is, typically, able to be removably fastened to the neck 215 through the presence of threads interior to the cap 214 and exterior to the neck 215. Such threads are not shown in FIG. 1. Those of ordinary skill in the art will also understand the basic physics associated with the suction connection of the suction cup 202 at the bottom of a prior-art dispenser 200 to the surface 206 on which the dispenser rests. Specifically, some downward force exerted on the dispenser 200 is transmitted to the top 205 of the suction cup 202. This force dispels air out from underneath the suction cup 202, thereby creating a volume of relatively low air pressure underneath the suction cup 202, and for this force to more effectively dispel air out from underneath the suction cup 202 the surface 206 upon which the dispenser 200 rests must be relatively hard, flat, and immobile surface such as a bathroom sink or a kitchen counter. Air at atmospheric pressure above the suction cup 202 pushes downwardly on the suction cup 202 and this results in the suction connection of the suction cup 202 to the surface 206 upon which the dispenser 200 rests. As previously indicated, air will seep under the edge 203 of the suction cup 202. Eventually, the air pressure underneath the suction cup 202 will return to atmospheric pressure. Such return to atmospheric pressure first weakens the suction connection and then causes the suction connection to be lost.

To operate the prior-art pump dispenser 200 shown in FIG. 1, the user pushes downwardly on a surface at the rear portion 219 of the nozzle 220. This force causes the stem 208 to move downwardly. This downward movement of the stem 208 is transmitted to the top 209 of the spring 210 within the spring chamber assembly 212. Since the spring chamber assembly 212 is firmly affixed to the cap 214 on the neck 215 at the top of the fluid reservoir 216, the bottom 211 of the spring 210 encounters a resistance from the piece 221 connecting the bottom 211 of the spring 210 with the bottom 213 of the spring chamber assembly 212. The result is that the spring 210 within the spring chamber assembly 212 is compressed. The volume within the spring chamber assembly 212 available to contain fluid is reduced. Because of the presence of the lower ball check valve 218, fluid 204 in the spring chamber assembly 212 is expelled upwardly through the upper ball check valve 222 through the stem 208 and then dispensed into the hand of the user through the nozzle 220. When the user releases downward pressure on the stem 208, the stored energy within the spring 210 returns the spring 210 to its uncompressed, relaxed state, thereby providing the stem 208 with an automatic upstroke. The volume of the spring chamber assembly 212 available to contain fluid 204 returns to its initial volume. Due to the presence of the upper ball check valve 222, the pocket of relatively low air pressure that has transiently formed within the spring chamber assembly 212 ultimately causes fluid 204 within the fluid reservoir 216 to be sucked through the opening 226 at the bottom of the fluid intake tube 224 into the spring chamber assembly 212. The dispenser 200 is now ready for another downstroke to be applied to the stem 208.

The path of transmission of downward force from the user to the top of the suction cup 202 that is associated with operation of the prior-art pump dispenser 200 shown in FIG. 1 can be seen to be:
User→stem 208→spring 210 within spring chamber assembly 212→bottom 213 of spring chamber assembly 212→cap 214 of fluid reservoir 216→neck 215 of fluid reservoir 216→side surfaces of fluid reservoir 216→bottom surface 217 of fluid reservoir 216→top 205 of suction cup 202

In a prior-art pump dispenser 200, the exertion of pressure on the top 205 of the suction cup 202 is delayed after the application of force from the user's hand to dispense fluid. Furthermore, by the time the force from the user's hand reaches the top 205 of the suction cup 202, the pressure exerted on the top 205 of the suction cup 202 has been significantly attenuated with respect to the pressure that would have been exerted on the top 205 of the suction cup 202 had the user somehow applied his or her downward force directly to the top 205 of the suction cup 202. Users of prior-art pump dispensers, such as the prior-art dispenser 200 described in FIG. 1, will understand that a strong, reliable suction connection to the surface around a sink or on a kitchen counter is difficult to obtain from the action of dispensing fluid from the pump dispenser.

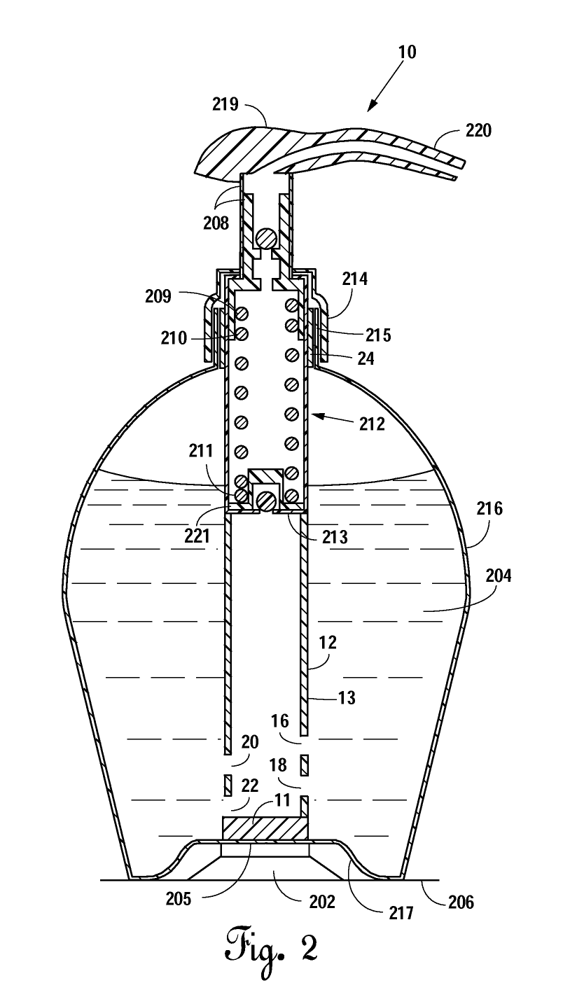

The preferred embodiment 10 of the disclosed invention is illustrated in FIG. 2. All unlabeled components are understood to have the same names and numbers that were shown in FIG. 1.

The operation of the embodiment 10 of the disclosed invention in a pump dispenser begins the same way as that of the prior-art pump dispenser 200 depicted in FIG. 1. Specifically, an individual pushes downwardly on a surface 219 at the rear of the nozzle 220. This downward force goes to the top of the stem 208. The whole stem 208 is moved downwardly. This downward movement of the stem 208 causes the top 209 of the spring 210 within the spring chamber assembly 212 to be pushed downwardly. The bottom 211 of the spring 210 meets resistance from the piece 221 connecting the bottom 211 of the spring 210 with the bottom 213 of the spring chamber assembly 212. However, in contrast to the prior-art pump dispenser 200 shown in FIG. 1, according to embodiment 10 of the present invention this resistance is not a result of the spring chamber assembly 212 being attached to the cap 214 on the neck 215 of the fluid reservoir 216.

According to the construction of the pump dispenser 10 of the present invention shown in FIG. 2, the spring chamber assembly 212 has been intentionally detached from the cap 214. The bottom 213 of the spring chamber assembly 212 is resistant to movement because a pillar tube 12 is placed underneath, and attached to, the spring chamber assembly 212. The pillar tube 12 shown in FIG. 2 takes the place of the fluid intake tube 224 used in the prior-art fluid dispenser 200 shown in FIG. 1. The bottom of the pillar tube 12 of the pump dispenser embodiment 10 is closed by the use of a solid disk 11, and the reasons for the use of this solid disk 11 will be given below.

The solid disk 11 of the pillar tube 12 rests on the inside of the bottom surface 217 of the fluid reservoir 216 prior to the user dispensing fluid from the pump dispenser 10. The downward movement of the pillar tube 12 is prevented by the bottom surface 217 of the fluid reservoir 216. This resistance to movement caused by the contact between the solid disk 11 of the pillar tube 12 with the bottom surface 217 of the fluid reservoir 216 causes the spring 210 within the spring chamber assembly 212 to be compressed.

The remainder of the operation of the pump dispenser 10 depicted in FIG. 2 is just as described with respect to the pump dispenser 200 depicted in FIG. 1, except that the release of stored energy from the spring 210 as it relaxes within the spring chamber assembly 212 is ultimately associated with fluid 204 from the fluid reservoir 216 being sucked into the spring chamber assembly 212 via the pillar tube 12 as opposed to being sucked into the spring chamber assembly 212 through the fluid intake tube 224 in the prior-art embodiment 200 shown in FIG. 1. Fluid entry into the pillar tube 12 in FIG. 2 is through one or more holes 16, 18, 20, 22 formed in the wall 13 of the pillar tube 12 as opposed to entering through a single opening 226 at the lower end of fluid intake tube 224 as shown in FIG. 1.

The path of transmission of the downward force exerted by the hand of the user to the top 205 of the suction cup 202 that is associated with the operation of the disclosed pump dispenser embodiment 10 with increased stability of the current invention can now be seen to be:
User→stem 208→spring 210 within spring chamber assembly 212→bottom 213 of spring chamber assembly 212→pillar tube 12→bottom surface 217 of fluid reservoir 216→top 205 of suction cup 202

According to embodiment 10 of the disclosed invention, the force exerted by the user is delivered from the spring chamber assembly 212 directly to the bottom surface 217 of the fluid reservoir 216 by the pillar tube 12. The force is therefore transmitted along a straight downward vector to the top 205 of the suction cup 202. This path for transmission of force to the top 205 of the suction cup 202 minimizes the delay in the exertion of pressure on the top 205 of the suction cup 202 after the application of force from the user's hand to the top of the pump dispenser 10. This path for transmission of force to the top 205 of the suction cup 202 also causes the force exerted on the top 205 of the suction cup 202 to be minimally attenuated with respect to the force that would have been exerted on the top 205 of the suction cup 202 had the user somehow applied his or her force directly to the top 205 of the suction cup 202.

The establishment of a suction connection by the act of starting the dispensing of fluid with the inventive construction of the pump dispenser 10 illustrated in FIG. 2 is therefore faster and stronger than the establishment of a suction connection with the prior-art pump dispenser 200 shown in FIG. 1.

The pillar tube 12 as shown in FIG. 2 serves three major functions. First, the pillar tube 12 helps to directly transmit the force applied by the user's hand to dispense fluid to the top 205 of the suction cup 202. This direct transmission of force permits the advantages provided by the embodiment 10 of the present invention to be experienced by the user. Second, the pillar tube 12 draws fluid from the fluid reservoir 216 as the fluid intake tube 224 of a prior-art dispenser 200 would normally do. Third, the pillar tube 12 helps to hold the spring chamber assembly 212 in position within the fluid reservoir 216 since the spring chamber assembly 212 is detached from the cap 214 on the neck 215 of the fluid reservoir 216.

A substantially cylindrical ring 24 is shown surrounding and affixed to the outer surface of the spring chamber assembly 212 in FIG. 2. The substantially cylindrical ring 24 shown in FIG. 2 ensures that the pillar tube 12 attached to the bottom 213 of the spring chamber assembly 212 will always be oriented in a substantially vertical direction within the fluid reservoir 216, and those of ordinary skill in the art will understand that this substantially vertical orientation of the pillar tube 12 allows the whole bottom rim of the pillar tube 12 to transmit force to the bottom surface 217 of the fluid reservoir 216 and therefore enables the pillar tube 12 to more effectively dispel air out from underneath the suction cup 202. The substantially cylindrical ring 24 illustrated in FIG. 2 keeps the pillar tube 12 oriented in a substantially vertical direction by preventing the entire stem 208-spring chamber assembly 212-pillar tube 12 combination from being tilted from a vertical axis. Such tilting from a vertical axis would most likely happen when the stem 208-spring chamber assembly 212-pillar tube 12 combination along with the cap 214—the top of which encircles the stem 208—is reconnected to the neck 215 of the fluid reservoir 216 after having been temporarily removed from the fluid reservoir 216 for the purpose of refilling the fluid reservoir 216 with fluid 204.

As was stated above, the bottom of the pillar tube 12 in the embodiment 10 shown in FIG. 2 is closed by the attachment of solid disk 11. Closing the bottom of the pillar tube 12 allows for an even distribution of the force to be transmitted from the bottom of the pillar tube 12 to the bottom surface 217 of the fluid reservoir 216 and, hence, to the top 205 of the suction cup 202. The result is a stronger suction connection of the suction cup 202 to the surface 206 on which the pump dispenser embodiment 10 of the present invention rests because more air is dispelled from underneath the suction cup 202. Furthermore, this even distribution of force reduces localized stress on the pillar tube 12, localized stress on the bottom surface 217 of the fluid reservoir 216, and localized stress on the suction cup 202. Such reduction of localized stress increases the service life of those respective components.

Those of ordinary skill in the art will understand that the fluid flow rate associated with the dispensation of fluid from a dispenser is in part a function of the precise means by which fluid is drawn from the fluid reservoir of the dispenser.

If the flow rate of the fluid dispensed using an embodiment of the disclosed invention needs to be changed, other designs for the pillar tube 12 are possible.

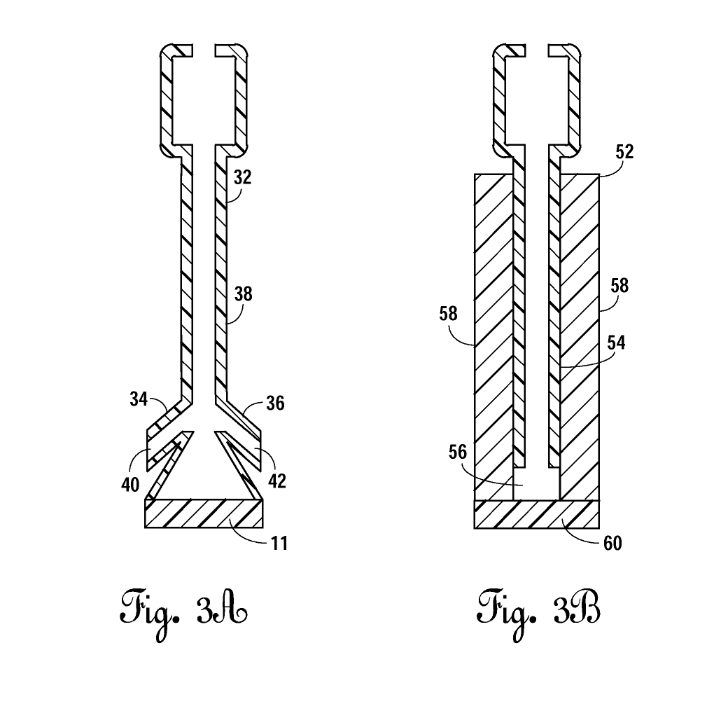

FIG. 3A and FIG. 3B illustrate two possible variations to the design of the pillar tube 12 shown in FIG. 2.

A first variation in the design of the pillar tube 12, shown in FIG. 3A, is a pillar tube 32 that includes two mini-tubes 34, 36. The mini-tubes 34, 36 emerge at an approximately 45° downward angle from the central portion 38 of the pillar tube 32. The open ends 40, 42 of the two mini-tubes 34, 36 provide for the entry of fluid 204 being sucked into the pillar tube 32 from the fluid reservoir 216.

A second variation in the design of the pillar tube 12 is the pillar tube 52 shown in FIG. 3B. A fluid intake tube 54 includes an opening 56 at its lower end. The solid disk 60 is attached to the bottoms of two or more columns 58 that are in turn attached to the outside surface of the fluid intake tube 54. The solid disk 60 rests on the bottom surface 217 of the fluid reservoir 216.

In the variation shown in FIG. 3B, each column 58 acts as a structural member for the transmission of downward force to the suction cup 202 at the bottom surface of the fluid reservoir 216. The columns 58 collectively serve the function of the single, larger-diameter pillar tube 12 shown in FIG. 2. The columns 58 transmit force to the top 205 of the suction cup 202 when the user of the pump dispenser 10 pushes down on the nozzle 220 and stem 208 of the dispenser 10.

Portions of the pillar tube structures illustrated in FIG. 2, FIG. 3A, and FIG. 3B could be combined into a single pillar tube structure. For example, a pillar tube structure could be built with holes, projecting mini-tubes beneath these holes, and attached slender columns leading down to a solid disk with no holes. Also, it is understood that all holes shown for fluid entry in FIG. 2 and in the variations of the design of the pillar tube 12 shown in FIG. 3A and in FIG. 3B can be altered considerably with regard to their shapes, numbers, and positions.

An increase in the force transmitted to the top 205 of the suction cup 202 from a downward stroke on the dispenser stem 208 will likely lead to better evacuation of the air located beneath the suction cup 202, and, consequently, a stronger suction connection of the suction cup 202 to the surface 206 on which the pump dispenser embodiment 10 of the current invention is resting.

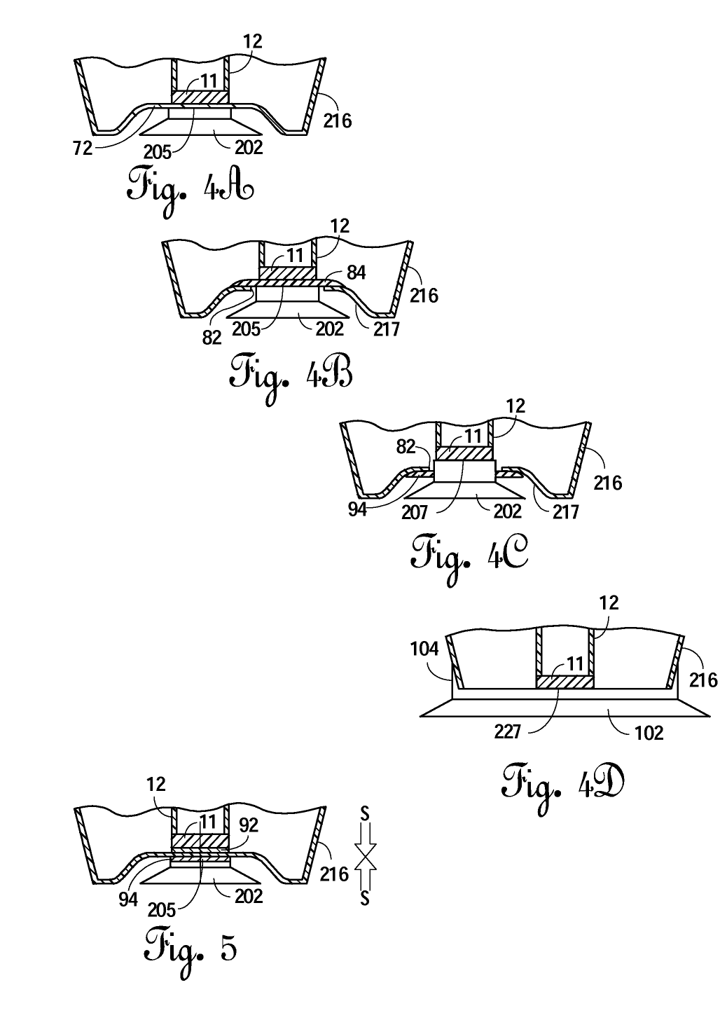

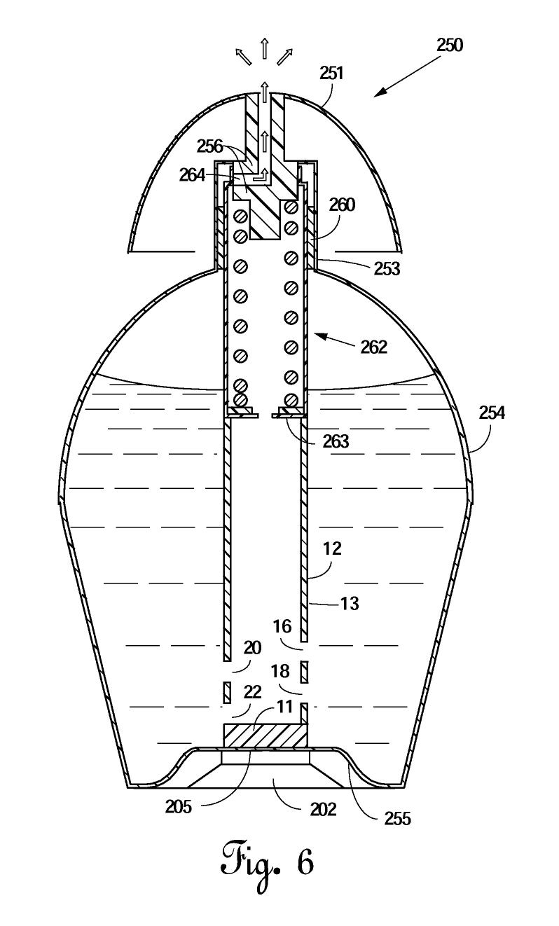

If there is a need for an even stronger suction connection than that associated with the pump dispenser 10 depicted in FIG. 2, FIGS. 4A, 4B, 4C, and 4D illustrate four variations to the suction cup and the area on the bottom surface 217 of the fluid reservoir 216 immediately above the suction cup 202.

Shown in FIG. 4A is a first alternate embodiment for the construction of the bottom surface of the fluid reservoir 216. In this embodiment, a section of flexible material 72 having greater flexibility than the side walls of the fluid reservoir 216 forms the bottom surface of the fluid reservoir 216.

Shown in FIG. 4B is a second alternate embodiment for the construction of the bottom surface of the fluid reservoir 216. Herein, a hole 82 is formed through the bottom surface 217 of the fluid reservoir 216. The hole 82 is directly above the suction cup 202. The hole 82 is covered by a flexible, fluid-impermeable membrane 84 that is firmly affixed to either of the interior or the exterior of the bottom surface 217 of the fluid reservoir 216. The top 205 of the suction cup 202 is attached to the flexible, fluid-impermeable membrane 84. The height of the suction cup 202 may be increased so that its upper end penetrates into the volume of the fluid reservoir 216, although the flexible, fluid-impermeable membrane 84 will, in that case, still lie between the suction cup 202 and the bottom of the pillar tube 12.

In FIG. 4A, the solid disk 11 of the pillar tube 12 rests on the flexible bottom surface 72 of the fluid reservoir 216. In FIG. 4B, the solid disk 11 of the pillar tube 12 rests on the flexible membrane 84. In both of these embodiments, the surface immediately above the suction cup 202 will flex more than in the embodiment shown in FIG. 2. This greater flexing of the surface immediately above the suction cup 202 will result in the transmission of more force to the top 205 of the suction cup 202 as a result of a downward stroke of the dispenser stem 208 than would be transmitted by the area of the bottom surface 217 of the fluid reservoir 216 immediately above the suction cup 202 of FIG. 2.

A third alternate embodiment for the construction of the bottom surface of the fluid dispenser 216, shown in FIG. 4C, also involves placement of a hole 82 in the region of the bottom surface 217 of the fluid reservoir 216 that is directly above the suction cup 202. In the embodiment shown in FIG. 4C, the top of the suction cup 202 has a greater height than that of the suction cup shown in FIG. 2. The upper end 207 of the suction cup 202 penetrates into the fluid reservoir 216. A washer-shaped, flexible, fluid-impermeable membrane 94 is tightly attached to the side of the suction cup 202 to seal the hole formed in the bottom surface of the fluid reservoir 216. The outer edge of the washer-shaped, flexible, fluid-impermeable membrane 94 is tightly affixed to either the interior or the exterior of the bottom surface 217 of the fluid reservoir 216 that surrounds the hole 82.

A fourth alternate embodiment for the construction of the bottom surface of the fluid reservoir 216, shown in FIG. 4D, involves the removal of the entire bottom surface 217 of the fluid reservoir 216. The bottom surface 217 of the fluid reservoir 216 is replaced with a large diameter suction cup 102. The upper edge of the large diameter suction cup 102 has an upward extension 104. The upward extension 104 wraps around, and is tightly attached to, the lower region of the outside side surface of the fluid reservoir 216.

In both of the embodiments shown in FIG. 4C and in FIG. 4D, the solid disk 11 of the pillar tube 12 directly rests on the top 207 and 227 of the suction cup 202 and 102, respectively, before use of the dispenser 10. The top of the suction cup 205 and 102 will therefore be likely to receive significantly more pressure than the top 205 of the suction cup 202 of FIG. 2 will receive when the pillar tube 12 transmits a downward force from the user's hand.

In the embodiments described in FIGS. 4A-4D, it is important that the length of the stem 208 situated above the cap 214 prior to the dispensing of fluid 204 has the proper height and/or that the surface immediately above the suction cup 202 has the appropriate stiffness such that the deformation of the surface immediately above the suction cup 202 upon each downward stroke of the stem 208 is sufficient to achieve a strong suction connection and yet not much greater than is necessary to achieve a strong suction connection.

Another variation to the embodiment 10 of the disclosed invention in a pump dispenser is the fabrication of the solid disk 11 from a heavy material. Making the solid disk 11 from a heavy material enables the effects described in the following paragraph.

First, each downstroke of the stem 208 will exert a greater force on the top 205 of the suction cup 202 because of the increased weight of solid disk 11. This greater force results in a stronger suction connection of the suction cup 202 to the surface 206 on which the pump dispenser 10 rests, since the force transmitted from the user to the top 205 of the suction cup 202 will be combined with the force associated with the increased weight of solid disk 11. Second, making the solid disk 11 from a heavy material will lower the center of gravity of the pump dispenser 10 along with increasing the mass of the pump dispenser. Both of these effects of this modification will reduce the chance of a downstroke on the stem 208 causing the pump dispenser to tip over or to move along the surface on which the pump dispenser rests.

Yet another variation to the embodiment 10 of the disclosed invention in a pump dispenser is illustrated in FIG. 5. This variation may be applied separately or in combination with what was illustrated in FIG. 3 and in FIG. 4. A first piece of ferromagnetic material 92 is either attached to the solid disk 11 of the pillar tube 12 or is attached to the bottom of the pillar tube 12 in lieu of a solid disk. A second piece of ferromagnetic material 94 is used to connect the bottom surface 217 of the fluid reservoir 216 to the top 205 of the suction cup 202. As shown in FIG. 5, the two pieces of ferromagnetic material 92, 94 are oriented with opposite polarity. The two pieces of ferromagnetic material 92, 94 will therefore magnetically repel each other when the pillar tube 12 experiences a downward force during fluid dispensation, and this magnetic repulsion will transmit a downward force to the top 205 of the suction cup 202 that adds to the force transmitted downwardly from the user's hand to the top 205 of the suction cup 202.

Because ferromagnetic materials are relatively heavy, the combined weight of the two pieces of ferromagnetic material 92, 94 will also add to the force transmitted by the user to the top 205 of the suction cup 202 when the user pushes downwardly on the nozzle 220 and stem 208. Furthermore, the weight of both pieces of ferromagnetic material 92, 94 will lower the center of gravity of the pump dispenser 10 and increase its overall mass, thus further reducing the chance of the dispenser turning over or moving along the surface on which it rests when the user begins to dispense fluid.

Those of ordinary skill in the art will understand that there are many additional ways to link the stem at the top of a dispenser with the suction cup at the bottom of the dispenser so that the force exerted by the user on the top of the dispenser not only dispenses fluid but also re-establishes or reinforces the suction connection of the suction cup at the bottom of the dispenser to the surface upon which the dispenser rests.

The disclosed invention can also be applied to aerosol dispensers, such as those used as air fresheners. This is because household aerosol dispensers include several of the basic structural features found in prior-art pump dispensers such as the one shown in FIG. 1, e.g., a fluid outlet, a spring chamber assembly, and a fluid intake tube.

Those of ordinary skill in the art will understand that while the structure of aerosol dispensers has similarities to that of the prior-art pump dispenser shown in FIG. 1, the means by which fluid is expelled from an aerosol dispenser is very different from the way fluid is expelled from a pump dispenser. In an aerosol dispenser the fluid reservoir is pressurized with a propellant gas. A downward stroke on the dispenser stem moves the stem such that an open path is created between the pressurized fluid reservoir and the outside air. Fluid is both pushed from the pressurized fluid reservoir into the fluid intake tube and is expelled outwardly through the fluid outlet as droplets (i.e., sprayed out) by the gas pressure within the pressurized fluid reservoir. The change in the volume of the spring chamber assembly able to contain fluid plays a relatively insignificant role in expelling the fluid from within the pressurized fluid reservoir. Also, ball check valves, such as those shown in FIG. 1, are generally not used in an aerosol dispenser.

Although the words “droplets” and “spray” were used in the preceding paragraph, it is understood that the fluid dispelled from an aerosol type dispenser could be dispensed as foam as well as in the form of a spray.

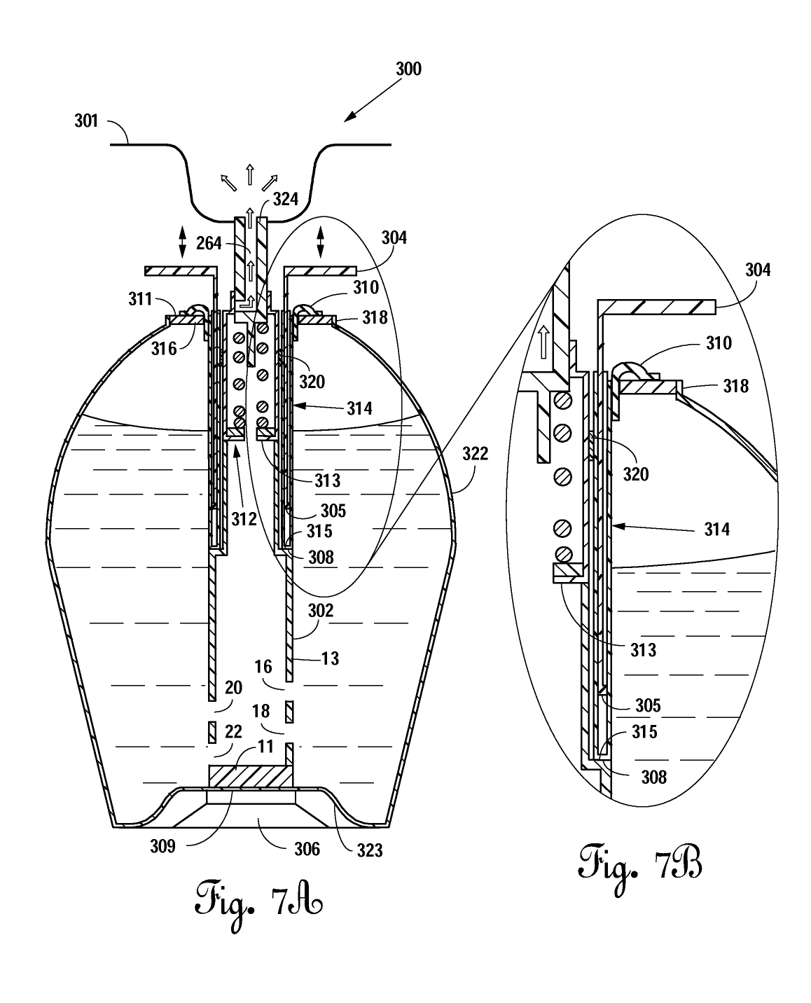

FIG. 6 shows an embodiment 250 of the disclosed invention in an aerosol dispenser.

As may be seen in FIG. 6, the spring chamber assembly 262 is detached from the top surface 253 of the fluid reservoir 254.

A substantially cylindrical ring 260 is surrounding and affixed to the spring chamber assembly 262 and ensures that the entire stem 256-spring chamber assembly 262-pillar tube 12 combination will always be oriented in a substantially vertical direction within the fluid reservoir 254.

When the hand of the user exerts a downward force on the top 251 of the aerosol dispenser 250, a path for the passage of fluid from within the pressurized fluid reservoir 254 to the fluid outlet 264 is opened.

The downward force from the hand of the user is transmitted to the stem 256 and then to the bottom 263 of the spring chamber assembly 262. Then, the pillar tube 12 transmits this force to the bottom surface 255 of the fluid reservoir 254 and the bottom surface 255 of the fluid reservoir 254 transmits this force to the top 205 of the suction cup 202. Consistent with the structural similarities between this aerosol dispenser embodiment 250 and the pump dispenser embodiment 10 of the disclosed invention that was shown in FIG. 2, the path for the transmission of downward force in the aerosol dispenser 250 from the user to the top 205 of the suction cup 202 is seen to be the same as the path of transmission of downward force previously described for the pump dispenser 10 shown in FIG. 2.

As will be described below, the disclosed invention can also be applied to Misto®-type dispensers. The process of fluid dispensation for Misto®-type dispensers is similar to that for aerosol dispensers. The key difference between a Misto®-type dispenser and an aerosol dispenser is that a Misto®-type dispenser does not retain a pressurized propellant gas to expel droplets of fluid. Rather, for Misto®-type dispensers, the pressurized gas generally used to expel droplets of fluid is air that has been mechanically pressurized by the user prior to fluid dispensation through use of a slide pump assembly included as a part of each Misto®-type dispenser. With this absence of a pressurized propellant gas within a Misto®-type dispenser, the fluid reservoir of a Misto®-type dispenser can be refilled with fluid in the same way that pump dispensers are refilled with fluid, that is, by temporary removal of the components that fit into the fluid reservoir of the dispenser.

FIG. 7A and FIG. 7B illustrate an embodiment of the disclosed invention in a Misto®-type dispenser 300. The specific shape of the pillar tube 302 attached to the bottom 313 of the spring chamber assembly 312 and to the bottom 315 of the slide pump assembly 314 will enable increased stability of this embodiment both during the actual dispensation of the fluid contained within the fluid reservoir 322 of the Misto®-type dispenser and during the mechanical generation of the pressure needed to propel the fluid from the Misto®-type dispenser 300 with the slide pump assembly 314. Further enabling the increased stability of this embodiment 300 is the use of a washer-shaped, flexible rubber piece 310 whose inner edge surrounds and is affixed to the exterior of the slide pump assembly 314 and whose outer edge is affixed to a substantially circular and flat ring 316 that in turn is firmly but removably attached to a notch 318 at the top of the fluid reservoir 322. The use of this washer-shaped, flexible rubber piece 310 will add to the increased stability of the embodiment 300 both during fluid dispensation and during pressure generation because the rubber piece 310 will permit more downward force to be transmitted to the pillar tube 302 upon a downward stroke of the stem 324 for fluid dispensation and upon a downward stroke of the plunger 304 of the slide pump assembly 314 for pressure generation than would be the case if the connection between the exterior of the slide pump assembly 314 and the substantially circular and flat ring 316 were a rigid connection. Finally, the spokes 320, which attach the spring chamber assembly 312 to the interior of the slide pump assembly 314 and which will be recognized to those of ordinary skill in the art as already appearing in prior-art Misto®-type dispensers, yet further enable the increased stability of this embodiment 300 both during fluid dispensation and during pressure generation because they ensure that the stem 324-spring chamber assembly 312-pillar tube 302 combination of the embodiment 300 is always positioned in a substantially vertical orientation. Those of ordinary skill in the art will understand that the illustration of the embodiment 300 in FIG. 7 omits the depiction of at least two features that are generally found in all Misto®-type dispensers. One feature omitted from FIG. 7 is a mechanism to mix air pressurized through use of the slide pump assembly 314 with fluid to be dispensed. A second feature omitted from FIG. 7 is a mechanism that allows the substantially circular and flat ring 316 to be firmly attached to the notch 318, to prevent the leakage of pressurized air from in between the ring 316 and the notch 318, and yet also allows the ring 316 to be removable from the notch 318 so that the user is able to pull out all of the components that fit into the fluid reservoir for the purpose of a fluid refill. These two omitted features are not needed to understand the enablement of increased stability in the Misto®-type dispenser 300.

For dispensation of fluid from the Misto®-type dispenser 300 by the user, force is transmitted from the user's hand at the top 301 of the embodiment 300 to the stem 324 and is then transmitted to the bottom 313 of the spring chamber assembly 312. This downward force is then conveyed by the pillar tube 302 to the bottom surface 323 of the fluid reservoir 322, and the bottom surface 323 of the fluid reservoir 322 then transmits that force to the top 309 of the suction cup 306 that is positioned on the bottom of the Misto®-type dispenser 300.

Furthermore, if the user ensures that the bottom 305 of the plunger 304 of the slide pump assembly 314 makes contact with the bottom 315 of the slide pump assembly 314 as the plunger 304 is being rapidly moved up and down by the user to generate the pressure needed to dispense fluid from the Misto®-type dispenser 300, then the force from the contact between the bottom 305 of the plunger 304 and the bottom 315 of the slide pump assembly 314 will be transmitted downward to the ledge 308 of the pillar tube 302, the pillar tube 302 will then transmit that force to the bottom surface 323 of the fluid reservoir 322, and the bottom surface 323 of the fluid reservoir 322 will then convey that force to the top 309 of the suction cup 306. Those of ordinary skill in the art will understand that increased dispenser stability will be more quickly attained during use of the slide pump assembly 314 if the first movement of the plunger 304 made in the process of pressure generation is a downward stroke that establishes contact between the bottom 305 of the plunger 304 and the bottom 315 of the slide pump assembly 314.

Application of the embodiment 300 of the disclosed invention may enable the manufacture of a Misto®-type air freshener dispenser that is both very convenient to use and safe.

Specifically, the fluid reservoir 322 of the dispenser 300 could be filled with a fragrant, propellant-free, non-toxic oil. A user could pump the plunger 304 of the slide pump assembly 314 two or three times with one hand and then, with the same hand, depress the top 301 of the dispenser 300 and spray out the fragrant, non-toxic oil. Application of this embodiment 300 would allow the user to keep the air freshener stationary throughout the use of the plunger 304 and throughout the actual dispensation of the fragrant, non-toxic oil.

Embodiments of the disclosed invention have described the direct transmission of fluid-dispensing force applied to a dispenser to the top of a suction cup located on the bottom of the dispenser. It is this application of a fluid-dispensing force that re-establishes or reinforces the suction at the bottom of the dispenser as soon as the dispenser has begun to be used, thereby significantly increasing dispenser stability. The disclosed invention may be more broadly generalized to include any linking of the dispensing of fluid with an increased stability of the dispenser. For example, the embodiments presented herein could be modified as disclosed in the following paragraphs.

The top of the spring within the spring chamber assembly could be pulled down by a means other than by a simple downward motion of the stem that is attached to the top of the spring. For example, the top of the spring could be pulled down by the movement of an outside lever. From a more general perspective, the word “direct” can be interpreted in a relative sense within the above description of the disclosed invention as involving a “direct” transmission of force from a user to the top of the suction cup of a given dispenser, i.e., the word “direct” can be taken to mean a mechanical pathway for the transmission of force that is more direct than the usual force transmission along the sides of the fluid reservoir of a prior-art dispenser. Accordingly, the initial force imparted by the user to dispense fluid could be in any direction and the exact path of force transmission from the user to the top of the suction cup could vary among different types of dispensers. Also, the disclosed invention should not be taken to preclude the use of simple means for the amplification of mechanical force during the transmission of force from the user to the top of the suction cup.

Furthermore, the disclosed invention could be applied to those dispensers for which a spring is not involved in dispensing fluid.

The stem-spring chamber assembly and the pillar tube could be separated from each other, with the resulting lower and upper portions of each of the stem-spring chamber assembly and pillar tube reconnected to each other with a spring. Such reconnection of the stem-spring chamber assembly and pillar tube with a spring could be helpful if the insertion of additional springs into the stem-spring chamber assembly-pillar tube combination might reduce wear on the main spring within the stem-spring chamber assembly.

The pillar tube could have either a narrower or wider diameter than the diameter of the top of the suction cup, provided that sufficient air can still be forced out from underneath the suction cup at the beginning of the dispensing of fluid. Changing the dimensions of the pillar tube may be necessary because the dimensions of the pillar tube may be restricted for reasons of cost or strength or for achievement of an adequate rate of fluid flow from the fluid reservoir. It is understood that a pillar tube with a relatively narrow diameter would have to be able to withstand the compression force associated with being repeatedly pressed toward a relatively immovable surface at its lower end. Also, those of ordinary skill in the art will know that even if the solid disk previously shown as closing the bottom of the pillar tube were made to be very flat or made to be hollow, and even if the disk were made to be hollow and the top surface of the disk were additionally removed, the disk could still help to evenly transmit force from the bottom of the pillar tube to the top of the suction cup. Furthermore, those of ordinary skill in the art will understand that this disk would not be necessary in the first place if the distribution of force transmitted from the edge of the lower end of the pillar tube directly to the bottom surface of the fluid reservoir could be shown to result in the application of a sufficiently well-distributed force to the top of the suction cup, and consequently a sufficiently strong suction connection of the suction cup to the surface on which the dispenser rests.

The presence of the pillar tube within the fluid reservoir does not preclude the simultaneous presence of a standard fluid intake tube placed in its standard location, and therefore located within the pillar tube. Fluid could flow from within the fluid reservoir into the pillar tube through its holes, be drawn into the opening of the standard fluid intake tube, and then be drawn into the stem-spring chamber assembly.

In both pump and aerosol dispensers, the stem-spring chamber assembly does not have to be detached from the cap or the top surface of the fluid reservoir if the cap or the top surface of the fluid dispenser have enough flexibility when the user pushes on the top of the stem to transmit sufficient force to the top surface of the suction cup.

In both pump and aerosol dispensers, the substantially cylindrical ring does not have to be directly affixed to the outer surface of the stem-spring chamber assembly. Specifically, there could be a gap between the substantially cylindrical ring and the stem-spring chamber assembly, with the substantially cylindrical ring possibly held in place around the stem-spring chamber assembly by spokes or by an extension arising from the outer surface of the stem-spring chamber assembly. The substantially cylindrical ring does not have to have a perfectly circular-shaped cross section. The substantially cylindrical ring could even be attached to a portion of the pillar tube instead of or in addition to the stem-spring chamber assembly. The important feature of the substantially cylindrical ring is that it has some presence at the opening of the fluid reservoir, and that its presence keeps the stem-spring chamber assembly-pillar tube combination in a substantially vertical orientation.

A substantially cylindrical ring need not be used at all. Instead, the stem-spring chamber assembly and the opening at the top of the fluid reservoir could each inherently have dimensions such that the stem-spring chamber assembly-pillar tube combination can only be oriented substantially vertically whenever the stem-spring chamber assembly-pillar tube combination is returned to the fluid reservoir after a temporary removal. Alternatively, a relatively shallow depression could be made in the bottom surface of the fluid reservoir so that the lower end of the pillar tube fits into the shallow depression. Such a structure would force the stem-spring chamber assembly-pillar tube combination to be oriented in a substantially vertical direction. If a shallow depression is formed in the bottom surface of the fluid reservoir, the user would guide the pillar tube into the corresponding depression every time the stem-spring chamber assembly-pillar tube combination is removed and returned to the dispenser. Moreover,

Yet another alternative to the use of a substantially cylindrical ring includes affixing the bottom of the pillar tube to the bottom surface of the fluid reservoir or to the top of the suction cup in cases where the bottom of the pillar tube directly rests on the suction cup prior to use of the dispenser. The stem-spring chamber assembly-pillar tube combination could then be designed to be separable to make it possible to remove some upper portion of the stem-spring chamber assembly-pillar tube combination to be able to refill the fluid reservoir. A design in which portions of the stem-spring chamber assembly-pillar tube combination are able to be separated would only be acceptable if, after the user completes a refill, rejoins the separated portions of the stem-spring chamber assembly-pillar tube combination, and then causes fluid to again flow upwards within the stem-spring chamber assembly-pillar tube combination, no air is able to leak into the stem-spring chamber assembly-pillar tube combination at the region at which the portions of the stem-spring chamber assembly-pillar tube combination are able to be separated.

Those of ordinary skill in the art will further recognize that, in pump and aerosol dispensers, the spring chamber assembly does not have to be detached from the cap or from the top surface of the fluid reservoir if, in response to a downward force from the user's hand, the cap or the top surface of the fluid reservoir are flexible enough to allow a sufficient downward movement of the spring chamber assembly and a corresponding sufficient transmission of force to the top of the suction cup.

The suction cup could be replaced with a hook-and-loop fastener attachment system in cases where the bottom surface of the fluid reservoir is made to be flat. In this scenario, one part of a hook-and-loop fastener attachment system could be affixed to the location at the bottom surface of the dispenser where the suction cup used to be and another part of the hook-and-loop fastener attachment system could be affixed to the surface on which the dispenser rests such that the two parts of the hook-and-loop fastener attachment system stick to one another. Force transmitted when the user dispenses fluid would re-establish or reinforce the connection between the two parts of the hook-and-loop fastener attachment system and consequently provide stability to the dispenser.

The suction cup at the bottom surface of the fluid reservoir could be made to be removable from the bottom surface if desired. For example, the suction cup could be designed to fit tightly into an upwardly projecting pocket at the bottom surface of the fluid reservoir. Such tight interfitment would enable temporary detachment of the suction cup from the bottom surface of the fluid reservoir as needed. Those of ordinary skill in the art will understand that other attachments that have been described within the above descriptions of embodiments of the disclosed invention could generally be achieved through interfitments.

The transmission of force could be substantially horizontal as opposed to being substantially vertical. For example, a dispenser including the disclosed invention could be rotated so that fluid dispensation reinforces a suction connection of the suction cup of the dispenser to a wall instead of to a horizontal flat surface such as a bathroom sink or kitchen counter. The fluid reservoir of such a dispenser would probably have to have a relatively restricted dimension perpendicular to the plane of the wall to prevent gravitational torque from interfering with the suction connection of the dispenser to the wall.

A pump dispenser including the disclosed invention could be a foam dispenser. Such a foam-dispensing dispenser would include a means of mixing air into the fluid to be dispensed and then homogenizing the resulting foam.

In addition to dispensing liquids, semi-solids, or liquids mixed within a propelling gas, a dispenser including the disclosed invention could dispense solids, gases, solids mixed within a propelling gas, or a mixture of solids and liquids that is mixed within a propelling gas. The dispenser could dispense any combination of flowable fluids.

Application of the disclosed invention to pump dispensers would enable the dispensing of small solids, such as ice cream sprinkles, which could be drawn into the nozzle within a stream of air. Application of the disclosed invention to aerosol dispensers would be appropriate for dispensing pressurized gas in cases where no separate propellant is needed.

### ADVANTAGES

Those of ordinary skill in the art will understand that the direct transmission of the force applied to dispense fluid located within the fluid reservoir of a dispenser to the top of a suction cup that is affixed to the bottom of the dispenser significantly reduces the probability that the dispenser will tip over or move across the surface on which it rests. A pump dispenser including the disclosed invention will therefore maintain its same location from use-to-use. Maintaining a pump dispenser in the same location from use-to-use will decrease the probability of dispensed fluid getting underneath the suction cup of the dispenser, which in turn will help to maintain the effectiveness of the suction cup, and will also enable its repetitive use in low light conditions by users with difficulty seeing.

The disclosed invention prevents the inconvenience of a plastic pump dispenser falling into a bathroom or kitchen sink or onto a shower floor. Further, the disclosed invention can prevent the destruction of a breakable dispenser and the possible danger of being injured when a glass, ceramic, or porcelain dispenser shatters after falling onto a floor or other hard surface.

It has also been found that the present invention enables those individuals with a reduced reach or with reduced motor skills to avoid tipping a fluid dispenser over or moving the dispenser to where it is not easily used. Such individuals may include children reaching up to activate a fluid dispenser, elderly individuals with arthritis, individuals having nerve or muscular diseases that limit range of movement, individuals with paraplegia, and individuals with cerebral palsy.

The relatively large surface area of the fluid reservoir of a dispenser can make it a repository for bacteria and viruses. Thus, those of ordinary skill in the art will see that the disclosed invention will lead to better hygiene because the users of a soap dispenser will no longer each have to apply a firm downward pressure on the fluid reservoir to ensure dispenser stability prior to the cleaning of their hands. Those of ordinary skill in the art will also see that hygiene will be improved from the significantly reduced chance of a dispenser falling into a sink or onto the floor.

Health care practitioners will particularly value the improvement in hygiene that will be realized from use of the disclosed invention. As they typically have to wash their hands numerous times each day, health care practitioners will also be likely to appreciate the time savings that will result from their no longer having to return their soap dispenser to its upright position or pick up their soap dispenser from the sink or from the floor.

Users of boats or recreational vehicles, in which surfaces do not remain stable, will appreciate the significantly increased hygiene and convenience associated with a dispenser not falling into the sink or onto the floor due to the motion of the boat or recreational vehicle.

The design of the fluid reservoir of prior-art fluid dispensers does not have to be modified to enable use of the disclosed invention, and those modifications to the bottom of prior-art fluid reservoirs that are associated with some embodiments of the disclosed invention would be very straightforward to make. Changes that would have to be made to a prior-art dispenser to allow for use of the disclosed invention would be relatively easy to implement. The pillar tube and substantially cylindrical ring could likely be made from inexpensive recyclable plastic. The reduction of the tendency of a plastic dispenser to fall down during use would allow manufacturers to make fluid reservoirs with plastic that is less robust than the plastic that is normally used to add weight to a dispenser for stability. The opportunity to reduce the amount of plastic used to manufacture a particular line of pump dispensers will save money for manufacturers and will benefit the environment as well by reducing the amount of energy used for the production of those plastic dispensers.

If a downward stroke applied to a dispenser will cause the dispenser to produce a light, a sound such as music, or a verbal message when dispensing fluid, then the dispenser will need a pressure or movement sensitive element to activate the light, sound, or verbal message. Through use of the disclosed invention, a pressure or movement sensitive element could be positioned in between the suction cup and the bottom surface of the dispenser and the force transmitted to the top of the suction cup when the user pushes on the top of the dispenser to dispense fluid could be used to activate this element. With this positioning of a pressure or movement sensitive element, the possibility of the element malfunctioning from exposure to fluid will be reduced.

If the fluid reservoir of a dispenser and the fluid that it contains are transparent or translucent, then the pillar tube will always be visible to the user of a dispenser that includes the disclosed invention. In such a case, the pillar tube could be made to have some decorative appeal. Those of ordinary skill in the art can see that the decorative appeal of the pillar tube could be achieved through constructing the pillar tube with a pleasant color pattern or with an interesting overall shape, such as a pillar from classical architecture, a rocket, a character that children like, and so on. The decorative appeal of the pillar tube might also include bubbles that emerge out of the holes in the pillar tube.

While the present invention has been disclosed according to its preferred and alternate embodiments, those of ordinary skill in the art will understand that additional embodiments have been enabled by the foregoing disclosure. Such additional embodiments shall fall within the scope and meaning of the appended claims and their legal equivalents.

I claim:

1. A pump dispenser for dispensing small amounts of fluid in response to manual force from the hand of a user, said pump dispenser including a fluid reservoir with an opening at the top thereof, a spring chamber assembly including check valves at the top and bottom thereof to enable the passage of fluid therethrough, said spring chamber assembly being located in the opening at the top of the fluid reservoir, said pump dispenser further comprising:
a movable system for receiving the manual force from the hand of the user;
said movable plunger constructed and arranged to cause the spring within the spring chamber assembly to compress in response to the manual force from the hand of the user;
a pillar tube extending from the bottom of the spring chamber assembly through the fluid reservoir to the bottom of the fluid reservoir;
said pillar tube constructed and arranged to transmit the manual force from the spring chamber assembly to the bottom of the fluid reservoir;
said pillar tube enabling the passage of fluid from within the fluid reservoir to the interior of the spring chamber assembly;
a force sensitive attachment device located on the exterior of the bottom of the fluid reservoir;
whereby the manual force from the hand of the user will cause a small amount of fluid to exit the spring chamber assembly and to be dispensed from the pump dispenser and will also cause force to be applied to said force sensitive attachment device on the bottom of the fluid reservoir by the transmission of force through said pillar tube thereby increasing the stability of the pump dispenser with respect to the surface on which it rests.

2. The pump dispenser as defined in claim 1 wherein said pillar tube includes a plurality of holes formed through the wall thereof.

3. The pump dispenser as defined in claim 2 wherein said pillar tube further includes a downwardly angled tube extending from at least one hole formed in the wall of said pillar tube.

4. The pump dispenser as defined in claim 1 wherein said pillar tube includes an opening at the bottom thereof and a plurality of columns formed along its outer wall.

5. The pump dispenser as defined in claim 1 wherein the transmission of force from the bottom of said pillar tube to the bottom of said fluid reservoir uses the repulsive force between like poles of magnetic pieces.

6. The pump dispenser as defined in claim 1 wherein said force sensitive attachment device is located on a flexible portion of the bottom of the fluid reservoir.

7. The pump dispenser as defined in claim 1 wherein said force sensitive attachment device is mounted within a hole formed in the bottom of the fluid reservoir.

8. The pump dispenser as defined in claim 1 wherein said force sensitive attachment device forms the bottom of the fluid reservoir.

9. The pump dispenser as defined in claim 1 wherein said force sensitive attachment device is a suction cup.

10. The pump dispenser as defined in claim 1 wherein said force sensitive attachment device is a hook-and-loop fastener attachment system.

11. An aerosol dispenser for dispensing small droplets of fluid in response to a manual force from the hand of a user, said aerosol dispenser including a pressurized fluid reservoir and a stem-spring chamber assembly for metering the flow of droplets located in the top of the pressurized fluid reservoir, said aerosol dispenser further comprising:
a surface for receiving the manual force from the hand of the user and transmitting said manual force to the stem-spring chamber assembly;
a pillar tube extending from the bottom of said stem-spring chamber assembly through the pressurized fluid reservoir to the bottom of the pressurized fluid reservoir;
said pillar tube constructed and arranged to transmit the manual force from the bottom of the stem-spring chamber assembly to the bottom of the pressurized fluid reservoir;
said pillar tube enabling the passage of fluid from within the pressurized fluid reservoir to the interior of the stem-spring chamber assembly;
a force sensitive attachment device located on the exterior of the bottom of the pressurized fluid reservoir;
whereby the manual force from the hand of the user will cause small droplets of fluid to exit the stem-spring chamber assembly and the manual force from the hand of the user will apply force to said force sensitive attachment device through said pillar tube thereby increasing the stability of the aerosol dispenser with respect to the surface on which it rests.

12. The aerosol dispenser as defined in claim 11 wherein said pillar tube includes a plurality of holes formed in the wall of said pillar tube.

13. The aerosol dispenser as defined in claim 12 wherein said pillar tube further includes at least one downwardly angled tube extending from a hole in the wall of said pillar tube.

14. The aerosol dispenser as defined in claim 11 wherein said pillar tube includes an opening at the bottom thereof and a plurality of columns formed along its outer wall.

15. The aerosol dispenser as defined in claim 11 wherein the transmission of force from the bottom of said pillar tube to the bottom of the pressurized fluid reservoir utilizes the repulsive force between like poles of magnetic pieces.

16. The aerosol dispenser as defined in claim 11 wherein said force sensitive attachment device is located on a flexible portion of the bottom of the pressurized fluid reservoir.

17. The aerosol dispenser as defined in claim 11 wherein said force sensitive attachment device is mounted within a hole formed in the bottom of the pressurized fluid reservoir.

18. The aerosol dispenser as defined in claim 11 wherein said force sensitive attachment forms the bottom of the pressurized fluid reservoir.

19. The aerosol dispenser as defined in claim 11 wherein said force sensitive attachment device is a suction cup.

20. The aerosol dispenser as defined in claim 11 wherein said force sensitive attachment device is a hook-and-loop fastener attachment system.

21. A Misto®-type dispenser for dispensing a fluid mist in response to manual force from the hand of a user, said Misto®-type dispenser including a fluid reservoir including an opening at the top thereof, a stem-spring chamber assembly for metering the flow of the fluid mist located in the top of the fluid chamber, and a sliding pump assembly, said Misto®-type dispenser comprising:
a surface for receiving the manual force from the hand of the user and transmitting the manual force to the stem-spring chamber assembly to dispense fluid;
a pillar tube extending from the bottom of the stem-spring chamber assembly through the fluid reservoir to the bottom the fluid reservoir;
said pillar tube constructed and arranged to transmit the manual force from the bottom of the stem-spring chamber assembly to the bottom of the fluid reservoir;
said pillar tube constructed and arranged to transmit the manual force on the sliding pump assembly to the bottom of the fluid reservoir;
said pillar tube enabling the passage of fluid from within the fluid reservoir to the interior of the stem-spring chamber assembly;
a force sensitive attachment device located on the exterior of the bottom of the fluid reservoir;
whereby the manual force from the hand of the user on the sliding pump assembly will generate the pressure needed to expel a fluid mist and apply force to said force sensitive attachment device through said pillar tube and the manual force from the hand of the user on the stem-spring chamber assembly to dispense fluid will apply force to said force sensitive attachment device through said pillar tube thereby resulting in increased stability of the Misto®-type dispenser with respect to the surface on which it rests.

22. The Misto®-type dispenser as defined in claim 21 wherein said pillar tube includes a plurality of holes formed in the wall of said pillar tube.

23. The Misto®-type dispenser as defined in claim 22 wherein said pillar tube further includes at least one downwardly angled tube extending from a hole in the wall of said pillar tube.

24. The Misto®-type dispenser as defined in claim 21 wherein said pillar tube includes an opening at the bottom thereof and a plurality of columns formed along its outer wall.

25. The Misto®-type dispenser as defined in claim 21 wherein the transmission of force from the bottom of said pillar tube to the bottom of the fluid reservoir utilizes the repulsive force between like poles of magnetic pieces.

26. The Misto®-type dispenser as defined in claim 21 wherein said force sensitive attachment device is located on a flexible portion of the bottom of the fluid reservoir.

27. The Misto®-type dispenser as defined in claim 21 wherein said force sensitive attachment device is mounted within a hole formed in the bottom of the fluid reservoir.

28. The Misto®-type dispenser as defined in claim 21 wherein said force sensitive attachment device forms the bottom of the fluid reservoir.

29. The Misto®-type dispenser as defined in claim 21 wherein said force sensitive attachment device is a suction cup.

30. The Misto®-type dispenser as defined in claim 21 wherein said force sensitive attachment device is a hook-and-loop fastener attachment system.

31. A method for stabilizing a dispenser used for dispensing a small amount of fluid in response to the manual force from the hand of a user wherein the dispenser includes a fluid reservoir, an opening at the top of the fluid reservoir, a stem-spring chamber assembly positioned within the opening at the top of the fluid dispenser for metering the flow of fluid dispensed from the fluid reservoir in response to the manual force from the hand of the user, and a pressure sensitive attachment device on the exterior of the bottom of the fluid reservoir, said method comprising the step of:
positioning a pillar tube to extend between the bottom of the stem-spring chamber assembly and the bottom of the fluid reservoir;
whereby the manual force from the hand of the user will cause a small amount of fluid to be dispensed from the fluid reservoir through the stem-spring chamber assembly and the manual force from the hand of the user will apply pressure to the pressure sensitive attachment device on the exterior of the bottom of the fluid reservoir by transmitting force from the bottom of the stem-spring chamber assembly to the bottom of the fluid reservoir and thence to the pressure sensitive attachment device on the exterior of the bottom of the fluid reservoir with said pillar tube.

32. The method as defined in claim 31 further including the step of detaching the stem-spring chamber assembly from the opening at the top of the fluid dispenser.
